(19) United States
(12) Patent Application Publication
(10) Pub. No.: US 2008/0232211 A1
(43) Pub. Date: Sep. 25, 2008

(54) Apparatus and Method For Reference Level Based Write Strategy Optimization

(75) Inventor: Ruud Vlutters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/090,372

(22) PCT Filed: Oct. 12, 2006
(86) PCT No.: PCT/IB2006/053750

§ 371 Date: Apr. 16, 2008

(30) Foreign Application Priority Data
Oct. 21, 2005 (EP) 05109842.4

(51) Int. Cl. G11B 7/125

(52) U.S. Cl. 369/47.51; 369/59.11

(57) ABSTRACT

The invention relates to an optical recording apparatus comprising means for optimizing a write strategy in a recording process. The apparatus comprising a radiation source for emitting a radiation beam in accordance with the write strategy, a read unit so as to provide a read signal, a bit detector for providing modulation bits corresponding to the read signal, a processing unit for grouping the modulation bits into modulation bit sequences and for correlating each modulation bit sequence of the read signal to a reference level, the reference level corresponding to the average amplitude of the read signal for a given modulation bit sequence. Average transition shifts of leading and/or trailing edges are determined based on the position of the reference levels, and at least one of the one or more write parameters in the write strategy is optimized in an optimization process based on the relative values of the reference levels. Optionally, the asymmetry of an optical effect may be determined from the reference levels so that the write strategy is optimized based on the asymmetry.

### FIELD OF THE INVENTION

The invention relates to an optical recording apparatus comprising an optimized write strategy control and to a corresponding method for optimizing a write strategy in an optical recording process. The invention relates in particular to the optimization of one or more parameters of the write strategy.

### BACKGROUND OF THE INVENTION

The optimal amount of radiation power required to record data on optical media (such as for example CD, DVD, and BD) depends inter alia on the specific medium used, on the recording speed, and may even depend on the location on the medium where the data is to be recorded. It is important that the correct radiation power is supplied to the medium, since incorrect radiation power settings may result in incorrect optical effects (often referred to as marks), such as too small or too large effects. Since these optical effects represent the recorded data, incorrect radiation power settings may consequently result in erroneous recordings.

In current generation DVD drives and next generation BD drives the radiation power and the write strategy used to record data on a disc has to be controlled very precisely. This may be done, for example, in the following way. After an initial optimization step (OPC, Optimum Power Control) based on jitter measurements and performed at the inner radius of a disc, the asymmetry is measured of the optical effects recorded while using the optimal settings found in the initial optimization step. After recording several tracks (for example, 100), the last track is read-back and the asymmetry of the recorded optical effects is measured. When the track appears to have a higher asymmetry than the optimum one the writing power is reduced, and when the track appears to have a lower asymmetry the write power is increased. This method of semi-continuous adaptation of the write power is called walking OPC, because only at specified intervals (or positions) the write power is modified when necessary.

The ever-increasing demand for larger storage capacity and higher access speed necessitates the use of more accurate and responsive control mechanisms for controlling the radiation power during recording. Therefore, there is a need in the art for improved optical recoding apparatuses and improved ways of ensuring optimal optical recording.

### SUMMARY OF THE INVENTION

The present invention seeks to provide an improved optical recording apparatus with means for ensuring optimized settings of the recording parameters during a recording process. The combination of recording parameters is often referred to as the write strategy.

The inventors had the insight that, until now, only a single parameter, that is the “average” asymmetry over all effect lengths (also referred to as run-lengths), is measured in the power control mechanism. Use of such a limited amount of information renders it problematic to fulfill the precise power control requirements as needed, for example, in high-speed BD recordings.

According to a first aspect of the present invention there is provided an optical recording apparatus with an optimized write strategy control, the apparatus comprising:
a radiation source for emitting a radiation beam so as to record optical effects on an optical record carrier and to read optical effects from the optical record carrier, the radiation beam being emitted in a recording situation in accordance with a write strategy including one or more write parameters,
a read unit for reading the recorded effects so as to provide a read signal, the read signal comprising first sections reflected from first regions on the record carrier with first lengths, and second sections reflected from second regions on the record carrier with second lengths, wherein transitions from the first to the second regions are labeled leading edges and transitions from the second regions to the first regions are labeled trailing edges,
a bit detector for providing modulation bits corresponding to the read signal,
a processing unit for grouping the modulation bits into modulation bit sequences, and for correlating each modulation bit sequence of the read signal to a reference level, the reference level corresponding to the average amplitude of the read signal for a given modulation bit sequence,
means for determining the average transition shifts of the leading and/or the trailing edges on the record carrier based on the values of the reference levels, and
means for setting at least one of the one or more write parameters in the write strategy based on the values of the reference levels.

The read signal may be (derived from) a measured optical signal, such as a measured optical signal reflected from a write-once or rewritable CD-type disc, DVD-type disc, BD-type disc, etc. The read signal is a modulated signal wherein the modulation represents the binary data stored on the disc. A typical encoding of the data stored on the disc is a run-length encoding, where information is stored in the lengths of the optical effects and in the lengths of the spaces between the optical effects. The bit pattern stored on a disc is in the run-length encoding represented by a timing sequence of transition shifts between spaces and optical effects (marks).

Optical effects are provided on an optical medium by driving the radiation source in accordance with a write strategy. In general the optical effects are written by means of radiation pulses with a pulse shape characterized by a number of write parameters. Typically, the write strategy includes a number of write parameters, such as commands to turn the radiation power on or off, setting the radiation power to specific levels, maintaining the radiation power for a given duration, etc..

A specific write strategy may depend upon the desired optical effect, such as upon the desired length of the effect. Standard write strategies may exist categorized according to the desired length of the optical effect to be recorded, i.e. I2-strategies for writing I2-marks, I3-strategies for writing I3-marks, etc.

It may be important, and sometimes even necessary, to calibrate (that is, to re-optimize) the write strategy not only before, but also during the recording of data on the optical recordable medium. This because a disc is not perfectly homogeneous, the system is heating up, etc.

In prior art systems where only the average asymmetry over all optical effects is measured, the amount of information is limited rendering it difficult to fulfill the precise power control requirements. By determining the average transition shifts of the leading and/or the trailing edges in the read signal based on the values of the reference levels, a more detailed and more complete optimization is performed in a apparatus according to the present invention. In an embodiment of the invention the average transition shifts are based on the relative values of these reference levels with respect to each other.

The present invention renders it possible to optimize a recording process on storage media having data capacities above 30 GB, such as, for example, in the range of 30-37 GB, since the reference levels may be provided for such data densities. This is an advantage since currently no alternative method exists for optimizing the recording process on such high-capacity media.

An embodiment of the apparatus according to the invention is defined in dependent claim 2. This embodiment has the advantage that by determining the asymmetry of an optical effect from the reference levels as a function of the length of the optical effect, it is rendered possible to extract run-length dependent asymmetry information from the reference levels, thereby enabling a run-length dependent optimization of the write strategy.

The asymmetry of a waveform is a direct measure of how long the marks are relative to the spaces, and by optimizing the write strategy based on the asymmetry correctly sized optical effects are ensured.

Further advantageous embodiments of the apparatus according to the invention are defined in dependent claims 3 to 5. In these embodiments a position of a reference level, and thereby a value of a transition shift to a given transition, is directly correlated to a power level, to a level duration, or to a timing of the write pulse. Optionally, these correlations are defined by rules that can be used by the processing means in order to optimize the write parameters.

An embodiment of the apparatus according to the invention is defined in dependent claim 6. This embodiment has the advantage that by reading a first part of the sequence of optical effects during a first part of the recording process, optimizing the write strategy in an optimization process, and subsequently using the optimized write strategy in a second part of the recording process, an optimal write quality is ensured for the entire recording process.

According to a second aspect of the present invention there is provided a corresponding method of optimizing a write strategy comprising one or more write parameters, the method comprising the steps of:
providing a measured read signal, the read signal comprising first sections reflected from first regions on a record carrier with first lengths, and second sections reflected from second regions on the record carrier with second lengths, wherein transitions from the first to the second regions are labeled leading edges and transitions from the second regions to the first regions are labeled trailing edges,
providing modulation bits corresponding to the read signal, the modulation bits being provided as a modulation bit sequence,
correlating each modulation bit sequence to a reference level, the reference level reflecting the running average amplitude of the read signal for a given modulation bit sequence,
determining average transition shifts of the leading and/or the trailing edges in the read signal based on the values of the reference levels, and
setting at least one of the one or more write parameters in the write strategy based on the average transition shifts.

According to a third aspect of the present invention there is provided an integrated circuit (IC) for controlling an optical recording apparatus in accordance with the present invention. This IC may be incorporated in an apparatus according to the first aspect of the present invention, or may alternatively be provided as a standalone IC (or chipset) that may be incorporated in any optical recording apparatus in order to include the optimization process of the present invention.

According to a fourth aspect of the present invention there is provided computer readable code for controlling an optical recording apparatus in accordance with the method according to the second aspect of the present invention. The computer readable code may control an IC, such as, for example, the IC according to the third aspect of the invention, in order to be able to control a recording apparatus so as to include the functionality of the optimization process of the present invention. In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which:

FIG. 1 schematically illustrates elements of an optical recording apparatus,

FIG. 2 schematically illustrates a series of channel bits from an optical signal,

FIG. 3 schematically illustrates an embodiment of a reference level extraction module,

FIGS. 4A and 4B illustrate the relation between the optical signal and the reference levels, and

FIG. 5 shows a schematic drawing of a 3T write strategy.

### DESCRIPTION OF EMBODIMENTS

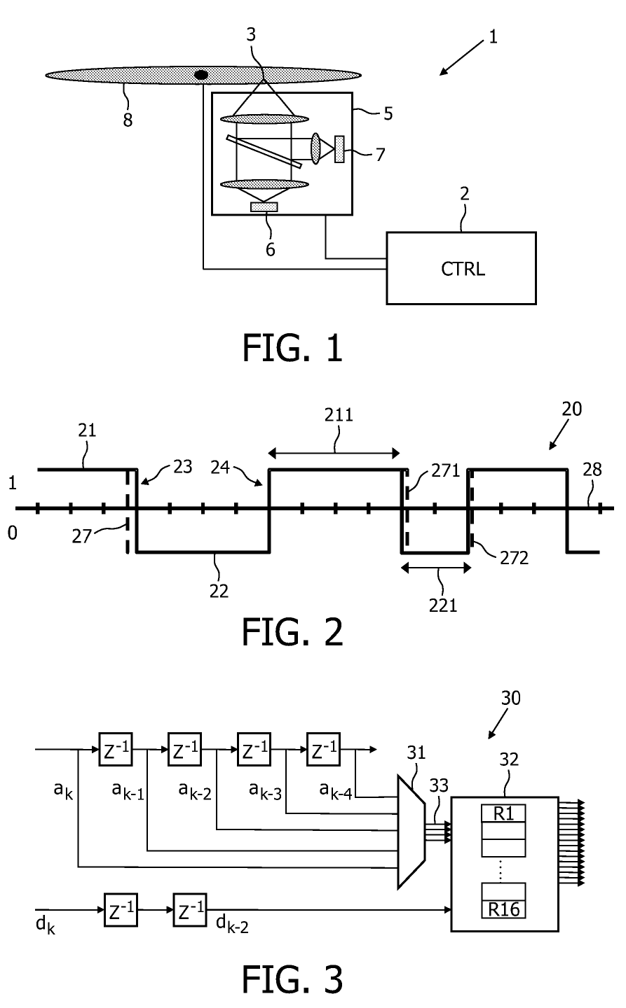

FIG. 1 schematically illustrates the elements of an optical recording apparatus 1 according to the present invention capable of reading and/or writing information from and/or to an optical record carrier 8. It is noted that an optical recording apparatus comprises a large number of elements with various functions, only the most relevant of which are illustrated here. Control means CTRL 2 refers to any type of control means used for controlling the optical recording apparatus. This control means CTRL 2 may include such control elements as mechanical control elements, electronic control elements, and microprocessor means. Mechanical control elements include motor means for rotating the disc shaped optical record carrier 8 and for moving the optical pickup unit 5. Electronic control elements include control elements for controlling the motion of the optical pickup unit 5. The microprocessor means (e.g., integrated circuit (IC) means) may include hardwired processing means and/or software processing means allowing a high-level control of the operation of the apparatus. Examples of high-level control include control over the settings of the pulse shape (that is, the write strategy) of the emitted laser power during recording mode.

The optical recording apparatus includes an optical pickup unit 5 (also referred to as an OPU). The optical pickup unit 5 includes a laser 6 for emitting a laser beam focused 3 on the disc by means of a number of optical elements. In recording mode the focused laser beam may be sufficiently intense so that a physical change is provided to the optical disc, that is, optical effects (marks) are provided onto the disc. Alternatively, in reading mode the power of the laser beam is insufficient to induce said physical change, and the laser light reflected from the disc is detected by a photo detector 7 for reading the optical effects (marks) on the disc.

The measured optical signal from the optical record carrier, as seen by the photo detector 7, is referred to as the high-frequency signal, or simply as the HF-signal. The signal measured by the photo detector 7 is transformed into a form which is suitable for further processing, either by a dedicated unit (not shown) or by processing means included in the control means CTRL 2.

FIG. 2 shows a signal illustrating a series of channel bits 20 from a read signal 40. The series of channel bits comprising first sections 21 corresponding to laser light reflected from first regions on the record carrier 8 with first lengths 211, representing spaces or high reflectivity regions, and second sections 22 corresponding to laser light reflected from second regions on the record carrier 8 with second lengths 221, representing marks or low reflectivity regions. The transitions from the first to the second regions are labeled leading edges 23, and transitions from the second regions to the first regions are labeled trailing edges 24.

The optical effects on a disc shaped record carrier 8 are normally aligned along a track generally spiraling from the center and outwards. These optical effects (represented by the second sections 22) are often referred to as marks, whereas the regions in between these marks (represented by the first sections 21) are often referred to as spaces. In a phase-change type disc (normally used as rewritable disc) the marks are amorphous regions with low reflectivity, whereas the spaces are crystalline regions with high reflectivity.

In optical recording the data is stored in a pattern of marks and spaces of different run-lengths, i.e. different lengths. Important for the optimal performance of a given disc is that the lengths of all marks and spaces are exact multiples of a standard channel bit length. For example, in BluRay Disc (BD) the shortest effects are 2 times a standard channel bit length (being a unit of length), also called I2's. The longest effects are 9 times the channel bit length and are called I9's. When the lengths of the marks and spaces are not exactly a multiple of the channel bit length, this will be seen as deviations from the optimal situation and will result in a deteriorated bit detection performance.

On a real disc the transitions between high reflectivity regions (spaces) and low reflectivity regions (marks) are not always in the right position. Some may be too much to the left (that is, too early in time; negative per definition), and some may be too much to the right (that is, too late in time; positive per definition). This is illustrated by the dot-dashed lines 27, 271, 272 which indicate the measured position of the transitions. In FIG. 2 the horizontal axis 28 represents a time axis. This time axis has a so-called 1T resolution (that is, one unit on the time axis corresponds to the duration of one channel bit). For an ideal signal the transitions 23, 24 should align exactly with the 1T units on the time axis.

In the following, embodiments of the present invention are described by way of example. In these embodiment values of measured reference levels are processed in order to extract timing information about the positions of the marks and spaces and about the positions of the transitions between the marks and spaces.

FIG. 3 illustrates an embodiment of a reference level extraction module 30, which may be part of the control means CTRL 2. A reference level can be seen as the average value of the HF-signal (representing the average laser light intensity) for a given modulation bit sequence. The number of reference levels dependents on the number of bits in such a sequence of modulations bits (aₖ₋₄ . . . aₖ) taken simultaneously in the calculations. Consequently, more or less reference levels than shown in this embodiment may be used without deviating from the present invention. The modulation bits aₖ are extracted from the digitized HF-signal dₖ, for example by means of a threshold detector or a Viterbi bit-detector. Viterbi detectors are often used in modern optical disc systems. When such a Viterbi bit-detector is used, the number of bits taken simultaneously in a sequence of modulation bits is directly related to the number of taps used in the Viterbi bit-detector. In the shown embodiment a 5-tap reference level extraction module 30 is described, in which a 17PP modulation code has 16 different reference levels (17PP being an abbreviation of (1,7)RLL Parity Preserve Prohibit Repeated Minimum Transition Run-length). However, it is to be understood that other amounts of taps (that is, number of modulation bits), and thereby more or less reference levels, can be processed alternatively. Consequently, embodiments wherein more or less reference levels than the sixteen shown in the present embodiment are measured are to be considered within the scope of the present invention. The reference levels may optionally be in the form of Viterbi reference levels. The reference levels may depend on the type of Viterbi detector used. When a Viterbi bit-detector is used, it is an advantage that run-length dependent asymmetry information may be extracted from the Viterbi reference levels since these reference-levels may be built-in in the hardware as part of the Viterbi bit-detection engine.

As mentioned above, an embodiment employing a sequence of five modulation bits (aₖ₋₄ . . . aₖ) is described with reference to FIG. 3. Thus, each reference level is an average over five modulation bits, and consequently the real time bit stream is delayed in time since at least five modulation bits need to be read in advance. Thereto the detected modulation bits aₖ are delayed by four delay units Z⁻¹. The digitized HF-signal dₖ is delayed by two delay units Z⁻¹, thereby synchronizing the modulation bits with the HF-signal. During each clock-cycle, five modulation bits (aₖ₋₄ . . . aₖ) are transformed into a 4 bit address 33 by an address encoder 31. This 4-bit address points to one of the 16 reference levels (R1 . . . R16) stored in a running average unit 32. The running average of the selected reference level is updated in this running average unit 32 with the time synchronized HF-signal dₖ₋₂, as obtained by delaying dₖ. The 16 up to date reference levels R1 to R16 are now available in the running average unit 32, and can be outputted for setting the write strategy parameters. By way of example, Table 1 shows the 5-bit sequences of modulation bits (aₖ₋₄ . . . aₖ) that are allowed when following the 17PP code for bit streams and the corresponding reference levels RL:

TABLE 1

| | Mod Bit Sequence |
|---|---|
| Ref Level | aₖ₋₄ . . . aₖ |
| R1 | 00000 |
| R2 | 00001 |
| R3 | 00011 |
| R4 | 00111 |
| R5 | 01111 |
| R6 | 11111 |
| R7 | 11110 |
| R8 | 11100 |
| R9 | 11000 |
| R10 | 10000 |
| R11 | 10011 |
| R12 | 01100 |
| R13 | 11001 |
| R14 | 00110 |
| R15 | 10001 |
| R16 | 01110 |

The first 10 reference levels (R1 to R10) each correspond to a modulation bit sequence with a single transition (that is, only one transition between a sequence of 0's and a sequence of 1's). These reference levels are mainly related to transitions from one long effect to another. Reference levels R11 and R13 sense how an I2 mark (with a low reflectivity, so two successive 0's) is positioned/sized, while reference level R12 and R14 contain information about the I2 spaces (with a high reflectivity, so two successive 1's). Finally, reference level R15 relates to I3 marks (three successive 0's), and reference level R16 to I3 spaces (three successive 1's).

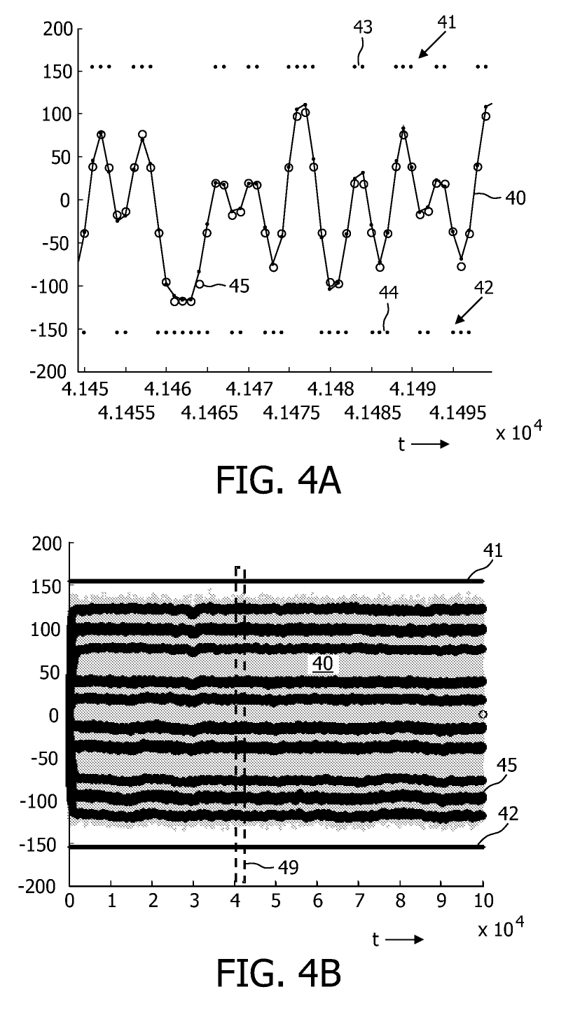

FIG. 4 illustrates the relation between the optical signal and the reference levels. FIG. 4A shows an optical signal 40 read from a 25 GB BD disc. The bits extracted from the optical signal are also shown and are denoted by the dots 41 and 42. The reference numeral 41 refers to high reflectivity regions, i.e. to spaces, and the reference numeral 42 refers to low reflectivity regions, i.e. to marks. The number of consecutive dots refers to the extracted run-length, for example, an I2 space run-length (2 consecutive dots) denoted by reference numeral 43 and an I3 mark run-length (3 consecutive dots) denoted by reference numeral 44 are shown. Moreover, overlapping the optical signal 40 are the 5-tap reference levels illustrated by the circles 45, where each circle correspond to the average amplitude of the read signal, and thereby to the average laser light intensity, for a given bit sequence.

FIG. 4B shows the running averages of the reference levels 45 over time t. In this plot the running average of the reference levels is illustrated by updating the graph after each clock-cycle (and therefore, after every new measurement). In is noted that FIG. 4A is in fact a strongly enlarged view of a part 49 of FIG. 4B. The bits 41, 42 extracted from the optical signal are also shown, however due to the updating they turn into a single solid line. Likewise, the optical signal 40 turns into a more or less fully covered area. In FIG. 4B only 10 out of the 16 reference levels 45 are visible. This is because in the given setup almost no channel distortion is present, resulting in several reference levels falling on top of each other. These overlapping reference levels may nevertheless be separated since each level is marked by the corresponding modulation bit sequence.

According to the present invention, information about the positions of the marks and of the spaces, more specifically about the positions of the transitions between the marks and the space, is extracted from the values of the reference levels and from the relation between these values.

Physically, the link between the modulation bits and the reference levels corresponds to a convolution of the optical spot focused on the record carrier with the marks and spaces on the record carrier. Mathematically, the link between the modulation bits and the reference levels can be expressed by the following matrix equation:

$$[ \begin{matrix}R 1 \\ R 2 \\ R 3 \\ R 4 \\ R 5 \\ R 6 \\ R 7 \\ R 8 \\ R 9 \\ R 10 \\ R 11 \\ R 12 \\ R 13 \\ R 14 \\ R 15 \\ R 16\end{matrix} ] = [ \begin{matrix}0 & 0 & 0 & 0 & 0 \\ 0 & 0 & 0 & 0 & 1 \\ 0 & 0 & 0 & 1 & 1 \\ 0 & 0 & 1 & 1 & 1 \\ 0 & 1 & 1 & 1 & 1 \\ 1 & 1 & 1 & 1 & 1 \\ 1 & 1 & 1 & 1 & 0 \\ 1 & 1 & 1 & 0 & 0 \\ 1 & 1 & 0 & 0 & 0 \\ 1 & 0 & 0 & 0 & 0 \\ 1 & 0 & 0 & 1 & 1 \\ 0 & 1 & 1 & 0 & 0 \\ 1 & 1 & 0 & 0 & 1 \\ 0 & 0 & 1 & 1 & 0 \\ 1 & 0 & 0 & 0 & 1 \\ 0 & 1 & 1 & 1 & 0\end{matrix} ] \cdot [ \begin{matrix}{h}_{- 2} \\ {h}_{- 1} \\ {h}_{0} \\ {h}_{+ 1} \\ {h}_{+ 2}\end{matrix} ]$$

in which Rx denote reference level x. The 16×5-matrix represent the modulation bit patterns (aₖ₋₄ . . . aₖ), and the h-vector describes the optical channel impulse response, where h₀ refers to the center intensity and h_{±1} and h_{±2}, refer to the intensities at plus and minus one, respectively two, clock units.

When the reference levels are measured, the optical channel impulse response vector h can in principle be found. The above matrix equation comprises 16 equations with only 5 unknown variables (h₋₂, h₋₁, h₀, h₋₁, and h₊₂). Using, for example, a least square error method one can solve such a problem.

However, if one tries to do solve the above matrix equation on a set of real experimentally measured reference levels, it appears almost impossible to fit all reference levels using such a simple model. This is mainly due to the fact that the asymmetry of the marks and spaces is not taken into account. According to the invention the influence of the asymmetry on the reference levels is incorporated into the model. The reference levels R1 to R10 (Table 1) are all related to single transition patterns (that is, there is only a single transition between a series of 0's and a series of 1's in each of the corresponding modulation bit sequences). Transitions from 1 (a high value in the signal) to 0 (a low value in the signal) represent the leading edges of a mark, and (possible) asymmetry is introduced in the model by replacing the 1 closest to the transition with a variable denoted L. An L-value below 1 mimics the effect of a mark that starts too early (such as for example transition 27 in FIG. 2). Similar, for all transitions from 0 to 1 (represent the trailing edges of a mark) the 1's are replaced with a variable denoted T, which mimics the edge shift 272 on the trailing edge of the marks.

All the edge shifts in the reference levels R11 to R16 (table 1) are specific for certain run-lengths. In order to also incorporate asymmetry into the model for these transitions, specific variables for each of the specific transitions are introduced. These specific variable are coded X(X)YZ, where X(X) is a one or two letter code with L representing a Leading edge and T representing a Trailing edge, Y is a numeral representing the length of the effect (for example X3Z is related to an I3 effect), and Z is a letter code with M indicating a Mark effect and S indicating a Space. Now, the matrix equation relating all the modulation bit patterns (aₖ₋₄ . . . aₖ) to the reference levels Rx can be written as:

$$[ \begin{matrix}R 1 \\ R 2 \\ R 3 \\ R 4 \\ R 5 \\ R 6 \\ R 7 \\ R 8 \\ R 9 \\ R 10 \\ R 11 \\ R 12 \\ R 13 \\ R 14 \\ R 15 \\ R 16\end{matrix} ] = [ \begin{matrix}0 & 0 & 0 & 0 & 0 \\ 0 & 0 & 0 & 0 & T \\ 0 & 0 & 0 & T & 1 \\ 0 & 0 & T & 1 & 1 \\ 0 & T & 1 & 1 & 1 \\ 1 & 1 & 1 & 1 & 1 \\ 1 & 1 & 1 & L & 0 \\ 1 & 1 & L & 0 & 0 \\ 1 & L & 0 & 0 & 0 \\ L & 0 & 0 & 0 & 0 \\ L 2 M & 0 & 0 & T2M & 1 \\ 0 & T 2 S & L 2 S & 0 & 0 \\ 1 & L 2 M & 0 & 0 & T 2 M \\ 0 & 0 & T 2 S & L 2 S & 0 \\ LT 3 M & 0 & 0 & 0 & LT 3 M \\ 0 & LT 3 S & 1 & LT 3 S & 0\end{matrix} ] \cdot [ \begin{matrix}{h}_{- 2} \\ {h}_{- 1} \\ {h}_{0} \\ {h}_{+ 1} \\ {h}_{+ 2}\end{matrix} ]$$

This matrix equation can, for example, be solved by the following two step method where
in a first step the optical channel impulse response vector h and the run-length L and T are solved based on reference levels R1 to R10, and where
in a second step the specific variables are solved based on the remaining reference levels.
Step 1: Solve h and the run-length L and T based on the reference levels R1 to R10: The first step can be solved, for example, by applying the well known Least-Square Error method, or, alternatively, by a computer based numerical method (for example using the well known software programs Maple or Mathematica). When a Least-Square Error method is used to solve the first ten equations of the matrix equation the h values can be found by calculating an error between the measured reference levels and the modeled reference levels, and convolving this error with the bit patterns in order to update h. The L and T variables can be found by attributing DC-error components to the corresponding L (reference levels R7 to R10) and T (reference levels R2 to R5). After a number of iterations the best fitting solution is found. In order to improve convergence one can force the solution to have a symmetrical h vector, so that there are fewer variables and so that the solution becomes better defined. Having estimated the optical channel impulse response vector h and the variables L and T, the specific variables for each of the specific transitions can now be determined in a second step.
Step 2: Solve the specific variables for the I2 and I3 run lengths based on the reference levels R1 to R16:
Step 2a; Solve L2M and T2M based on the known h vector, and on R11 and R13 (2 equations with 2 unknown):

$$\begin{matrix}L 2 M = - \frac{{h}_{2}^{2} - {h}_{2} R 11 - {h}_{1} {h}_{- 2} + {h}_{1} R 13}{- {h}_{- 1} {h}_{1} + {h}_{2} {h}_{- 2}} \\ T 2 M = \frac{- {h}_{- 2}^{2} + {h}_{- 1} {h}_{2} - {h}_{- 1} R 11 + R 13 {h}_{- 2}}{- {h}_{- 1} {h}_{1} + {h}_{2} {h}_{- 2}}\end{matrix}$$

Step 2b; Solve L2S and T2S based on the known h vector, and on R12 and R14 (2 equations with 2 unknown):

$$\begin{matrix}L 2 S = - \frac{- {h}_{- 1} R 14 + R 12 {h}_{0}}{- {h}_{0}^{2} + {h}_{- 1} {h}_{1}} \\ T 2 S = \frac{- {h}_{0} R 14 + {h}_{1} R 12}{- {h}_{0}^{2} + {h}_{- 1} {h}_{1}}\end{matrix}$$

Step 2c; Solve LT3M based on the known h vector and on R15 (1 equation with only 1 unknown):

$$LT 3 M = \frac{R 15}{{h}_{- 2} + {h}_{2}}$$

Step 2d; Solve LT3S based on the h vector and on R16 (1 equation with only 1 unknown):

$$LT 3 S = \frac{- {h}_{0} + R 16}{{h}_{- 1} + {h}_{1}}$$

In the above example, the asymmetry of the run-lengths involving transitions from one long effect to another (reference levels R1 to R10) are determined, the asymmetry of I2 run-lengths (reference levels R11 to R14) is determined, and the asymmetry of I3 run-lengths (reference levels R15 to R16) is determined. It is to be noted that by utilizing more reference levels, an even more detailed asymmetry determination for the various run-lengths can be made and/or the asymmetry of more run lengths, than only for the I2 and I3 effects as in the example above, can be determined.

By facilitating asymmetry determinations for the different run-lengths, a more precise control of a write strategy is facilitated. This may be especially suited for advanced walking OPC methods. In such a walking Optimum Power Calibration method the write strategy is normally optimized in a reserved zone on the disc before the actual recording of the data. Next, the system starts recording the data. After recording a predefined number of tracks, the system jumps one track back and analyses the quality of the last written track. It might be needed to adapt the write strategy slightly to improve write performance, because the disc is not perfectly homogeneous, the system is heating up, etc. This process is repeated at predefined intervals, and in this way the entire disc can be reliably written. Normally only the write power can be adapted, because only one parameter is measured when reading the last written track. However, by providing the run-length dependent asymmetry it is possible to adapt more than one parameter in the write strategy. Alternatively, it is possible to adapt specific parameters in a given write strategy.

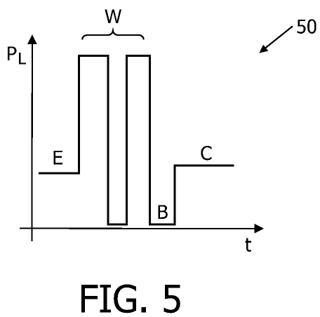

FIG. 5 shows a schematic drawing of a 3T mark write strategy 50. The laser power P_{L} is shown as a function oftime t. A write strategy defines the laser light pulse used to form the various optical effects (marks) on the record carrier. The illustrated write strategy comprises a number of write parameters, that is four power levels (E, W, B, C) and a time duration for each of these power levels. The laser starts with an erase power level (E), followed by a writing pulse having a write power level (W). After the write pulse the power is reduced to a bias power level (B) in order to quench the phase-change material. Finally, an erase pulse with power level C is used to recrystallize a part of the amorphous mark in order to put the trailing edge in the right position. The pulse shape of the write pulse may be adapted according to the disc type by specifying the number of sub-pulses and the duration of each of the sub-pulses. In the example of FIG. 5 a write pulse consisting of two sub-pulses having a power level W with a bias power level B in between is shown by way of example. It is pointed out that the invention is not limited to a write strategy of the type illustrated in FIG. 5, and the figure is provided only as an example of a write strategy.

Based on the present invention, one or more write parameters in a write strategy can be optimized in an optimization process based on the values of the reference levels. In an embodiment of the invention this optimization process is based on the values of the reference levels relative to each other. The one or more write parameters may include a power level, a power level duration, a timing of a pulse or sub-pulse, etc..

In the embodiment described above, the asymmetry of the long run-length optical effects can be extracted, as well as the run-length specific L2M/T2M and L2S/T2S transitions (for the I2 effects) and LT3M and LT3S transitions (for the I3 effects). Based on these asymmetries one can adjust specific parameters settings in the write strategies for recording the I2 and I3 effects, which effects are the most critical ones for obtaining a reliable recording of data.

Generally is it possible to evaluate the average transition shifts and optimize at least one of the one or more write parameters in the write strategy in accordance with some predefined rules, for example based on a determined asymmetry. Such rules include a relationship between the run-length dependent asymmetries and the settings of the various parameters in the write strategy. Alternatively, such rules include schemes of how to determine which write strategy (or strategies) is to be optimized, and/or of schemes of how to determined which ones of the parameters in a write strategy are to be adjusted, as well as the extent of the adjustment.

Although the various aspects of the present invention have been described in connection with preferred embodiments, it is not intended to be limited to the specific form set forth herein. Rather, the scope of the present invention is limited only by the accompanying claims. In the above, certain specific details of the disclosed embodiments are set forth for purposes of explanation rather than limitation, so as to provide a clear and thorough understanding of the present invention. However, it should be understood by those skilled in this art that the present invention might be practiced in other embodiments that do not conform exactly to the details set forth herein without departing significantly from the spirit and scope of this disclosure. Further, in this context, and for the purposes of brevity and clarity, detailed descriptions of well-known apparatuses, circuits, and methodologies have been omitted so as to avoid unnecessary detail and possible confusion. The elements of the apparatus according to the invention may be implemented by means of several distinct items of hardware or several elements may be combined into one an the same item of hardware. Moreover, some elements may be implemented by a suitably programmed processor.

Reference signs are included in the claims. However the inclusion of these reference signs is only for clarity reasons and should not be construed as limiting the scope of the claims.

1. Optical recording apparatus (1) with an optimized write strategy control, the apparatus comprising:
a radiation source (6) for emitting a radiation beam so as to record optical effects on an optical record carrier (8) and to read optical effects from the optical record carrier, the radiation beam being emitted in a recording situation in accordance with a write strategy (50) including one or more write parameters (E, W, B, C),
a read unit (7) for reading the recorded effects so as to provide a read signal (40), the read signal comprising first sections (21) reflected from first regions on the record carrier with first lengths (211), and second sections (22) reflected from second regions on the record carrier with second lengths (221), wherein transitions from the first to the second regions are labeled leading edges (23) and transitions from the second regions to the first regions are labeled trailing edges (24),
a bit detector for providing modulation bits corresponding to the read signal (40),
a processing unit for grouping the modulation bits into modulation bit sequences (aₖ₋₄ . . . aₖ), and for correlating each modulation bit sequence of the read signal to a reference level (Rx, 45), the reference level corresponding to the average amplitude of the read signal (40) for a given modulation bit sequence,
wherein the apparatus further comprises
means for determining the average transition shifts of the leading (27, 271) and/or the trailing edges (272) on the record carrier based on the values of the reference levels, and
means for setting at least one of the one or more write parameters in the write strategy based on the values of the reference levels.

2. Apparatus according to claim 1, comprising means for determining an asymmetry of an optical effect from the reference levels (Rx, 45) as a function of the length of the optical effect (211, 221), and means for setting at least one of the write strategy (50) parameters based on said determined asymmetry.

3. Apparatus according to claim 1, wherein the one or more write parameters include a power level (E, W, B, C) and/or a power level duration.

4. Apparatus according to claim 1, wherein the one or more write parameters include a timing of a write pulse in the radiation beam, the timing being obtained in relation to a reference clock.

5. Apparatus according to claim 1, comprising means for evaluating the average transition shifts of the leading and/or the trailing edges, and means for optimizing at least one of the one or more write parameters (E, W, B, C) in the write strategy (50) in accordance with predefined rules.

6. Apparatus according to claim 1, comprising control means operative for recording a sequence of optical effects on a recordable medium, and wherein the read unit is operative for reading a first part of said sequence during a first part of the recording process and for obtaining the read signal from said first part of the sequence,
the at least one of the one or more write parameters in the write strategy being set in dependence on the read signal obtained from said first part of the sequence,
the control means further operative for recording a sequence of optical effects in a second part of the recording process while the set parameters in the write strategy are being used.

7. Integrated circuit (IC) for use in an optical recording apparatus, the IC being adapted to set one or more write parameters (E, W, B, C) in a write strategy (50) according to an average transition shifts of the leading (23) and/or the trailing edges (24) of a measured read signal (40), the average transition shifts being determined based on the values of reference levels (Rx, 45), the reference level reflecting the amplitude of the read signal (40) for a given modulation bit sequence (aₖ₋₄ . . . aₖ).

8. Computer readable code for controlling an optical recording apparatus, the apparatus being controlled to optimize one or more write parameters (E, W, B, C) in a write strategy (50) according to the average transition shifts of leading (23) and/or trailing edges (24) of a measured read signal (40), the average transition shifts being determined based on the value of reference levels (Rx, 45), the reference level reflecting the amplitude of the read signal for a given modulation bit sequence (aₖ₋₄ . . . aₖ).

9. Method of optimizing a write strategy (50) comprising one or more write parameters (E, W, B, C), the method comprising the steps of:
providing a read signal (40), the read signal comprising first sections (21) reflected from first regions on a record carrier with first lengths (211), and second sections (22) reflected from second regions on the record carrier with second lengths (221), wherein transitions from the first to the second regions are labeled leading edges (23) and transitions from the second regions to the first regions are labeled trailing edges (24),
providing modulation bits corresponding to the read signal, the modulation bits being provided as a modulation bit sequence (aₖ₋₄ . . . aₖ),
correlating each modulation bit sequence to a reference level (Rx, 45), the reference level reflecting the running average amplitude of the read signal (40) for a given modulation bit sequence (aₖ₋₄ . . . aₖ),
wherein average transition shifts of the leading (27, 271) and/or the trailing edges (272) are determined in the read signal based on the values of the reference levels, and wherein at least one of the one or more write parameters in the write strategy is set based on the average transition shifts.
